(19) United States
(12) Patent Application Publication
(10) Pub. No.: US 2009/0090250 A1
(43) Pub. Date: Apr. 9, 2009

(54) Multi Grill

(75) Inventors: Shaohui Zhou, Xiamen (CN); Ji Kou, Xiamen (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: Tsann Kuen (China) Enterprise Co., Ltd., Xiamen (CN)

(21) Appl. No.: 12/058,936

(22) Filed: Mar. 31, 2008

(30) Foreign Application Priority Data
Mar. 30, 2007 (CN) 20072000665.9

(51) Int. Cl. A47J 37/10

(52) U.S. Cl. 99/422

(57) ABSTRACT

A multi grill is disclosed in the present invention. The multi grill includes a main grill comprising a first shell, a first frying plate mounted on the first shell, a first electric heating device mounted inside the first shell for heating the first frying plate, and a power cord connecting a first electric heating device and a power source; at least a secondary grill comprising a second shell, a second frying plate mounted on the second shell, a second electric heating device mounted inside the second shell for the second frying plate; the main grill connects the secondary grill via a power plug and a power socket, and the secondary grill gains power supply for heating the second electric heating device from the main grill. A main grill can couple with multi secondary grills, and only the main grill is needed to connect with the power source via a power cord. The secondary grills need not any connecting power cords, without the multifarious power cords, so they are suitable for multi-people having dinner at the same time

### FIELD OF THE INVENTION

The present invention relates to a grill, and more particularly relates to a multi grill suitable for use by several people at the same time.

### RELATED ART

Grills are used for grilling food or keeping food at a desired temperature, and they have wider and wider applications. Grills can prevent food from being cooled in the process of having dinner. These grills usually include a shell having a heating plate on the surface of the shell, and an electric heating device for heating the heating plate inside the shell. The electric heating device connects with a power source via power cords.

The heating plate has a limited area for placing food, so commonly a grill can just offer a cooking area for 1-2 people at the same time. If there are several people having dinner at the same time, several grills which each must connect to a power source are needed for these users. Thus it is a inconvenience for these users that too many power cords are in the dinner place, which affects the dinner environment and easily causes the danger of tripping.

### SUMMARY OF THE INVENTION

The present invention provides a multi grill, whose primary objective is to obviate the disadvantage of existing grills that can not offer enough cooking area for several people to use at the same time.

The objective of the present invention will be apparent in the ensuing description.

A multi grill is provided in the present invention. The multi grill includes a main grill comprising a shell, a frying plate mounted on the shell, an electric heating device positioned inside the shell for heating the frying plate, power cords for connecting the electric heating device with the power source; at least a secondary grill comprising a shell, a frying plate mounted on the shell, an electric heating device mounted inside the shell for heating the frying plate; the main grill connects the secondary grill via a power plug and a power socket, and the secondary grill gains the power supply for the electric heating device from the main grill.

According to one embodiment of the present invention, the aforementioned secondary grill including at least two grills coupling together via a power plug and a power socket in turn, herein the electric heating device of the rear secondary grill obtains power from the front secondary grill.

According to one embodiment of the present invention, the aforementioned secondary grill has a power cord connecting the electric heating device with the power source.

According to one embodiment of the present invention, the aforementioned power socket protrudes through the shell from the inside to the outside, and its inside terminal forms a flange coupling with the shell via bolts. The power plug has a groove whose size and shape is matching the power socket, and the groove has an insert matching the jack of the power socket. The power plug is located through the shell from outside to inside, and its outside terminal having a flange contacting with the outer surface of the shell, its side surface having a flexible hook contacting with the inside surface of the shell, thereby making the power plug fixed in the shell via the hook.

According to one embodiment of the present invention, the aforementioned shell includes a rectangular frame and a bottom cover, the bottom cover having hooks, the bottom of the frame having holes matching the hooks, the bottom cover located below the frame through the cooperation of the holes and hooks, and the bottom cover is locked and fastened with the frame by bolts.

According to one embodiment of the present invention, the aforementioned frying plate is a glass plate, a heating plate positioned below the glass plate, and the heating plate is located on the bottom cover by four Z-shape brackets.

According to one embodiment of the present invention, the aforementioned multi grill further includes two feet installed in the two parallel sidewalls of the frame, and fastened by bolts. The outside of the two feet have handles, which are fastened to the feet by bolts.

According to one embodiment of the present invention, the distance between the portions of the two feet protruding out the bottom of the frame body is longer than the distance between the other two parallel sidewalls which are without feet.

According to one embodiment of the present invention, a thermostat for controlling the temperature of the heating plate is located inside one of the feet, a gear formed on the turning knob of the thermostat, a rack meshed with the gear located slidable inside the feet, a push-button mounted slidable on the handle corresponding to the feet, and the push-button has a extending terminal inserted in said rack.

According to one embodiment of the present invention, the aforementioned frying plate is a glass plate.

As shown in the above-mentioned description, the present invention has advantages as follows compared to existing grills. First, a main grill can couple with multi secondary grills, and only the main grill needs to connect to the power source via a power cord, the secondary grills do not need to connect to power cords. Without the multifarious power cords, they are suitable for many people having dinner. Second, the number of secondary grills depend on the cooking requirement, and the number of secondary grills can be selected depending on the number of dinner users. Third, every secondary grill has the same structure and can be replaced by each other randomly, i.e. if one of the secondary grills has a problem, it can be removed without any effect on the other secondary grills, or by the other secondary grill used for replacing the problem secondary grill. Fourth, the main grill and the secondary grills can be piled up together if they are not in use. It saves room because the two close grills can be located on each other by the feet.

### BRIEF DESCRIPTION OF THE DRAWINGS

FIG. 1 is an appearance perspective view of the main grill or secondary grill of the present invention;

FIG. 2 is an exploded view of the main grill or the secondary grill of the present invention;

FIG. 3 is a perspective view of the main grill connecting with a secondary grill of the present invention;

FIG. 4 is a sectional view of FIG. 3;

FIG. 5 is a partial enlargement view of A of FIG. 4.

### DETAILED DESCRIPTION OF THE PREFERRED EMBODIMENTS

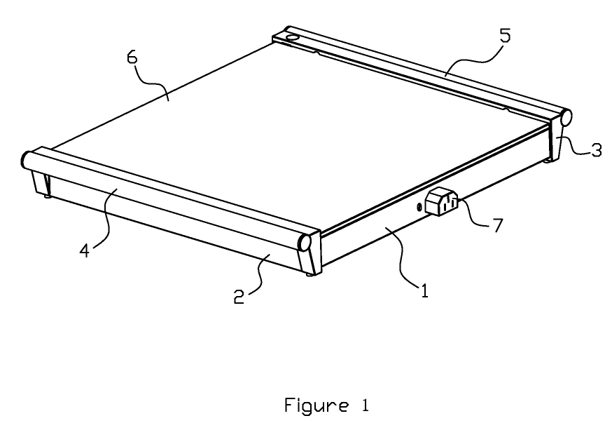

Preferred embodiments of the present invention will be described in detail with reference to FIG. 1 to FIG. 5.

A multi grill provided in this embodiment includes a main grill and at least a secondary grill. The secondary grill may have the same structure or may be a little different than the main grill. The main grill or the secondary grill is named depending on which one connects with the power source directly or not. The grill connecting with the power source directly is named the main grill, and the other grill obtaining power from the main grill is named the secondary grill. The main grill connects with the power source directly via power cords, and the secondary grill gains power from the main grill or its superior secondary grill via the cooperation of power plug and socket. Alternatively, the secondary grill also can have power cords, but when it is used as the secondary grill, it obtains power from the main grill. It does not use power cords. For the sake of illustrating conveniently, the present embodiment presumes that only the main grill has power cords and the secondary grill does not have power cords directly connecting to the power source.

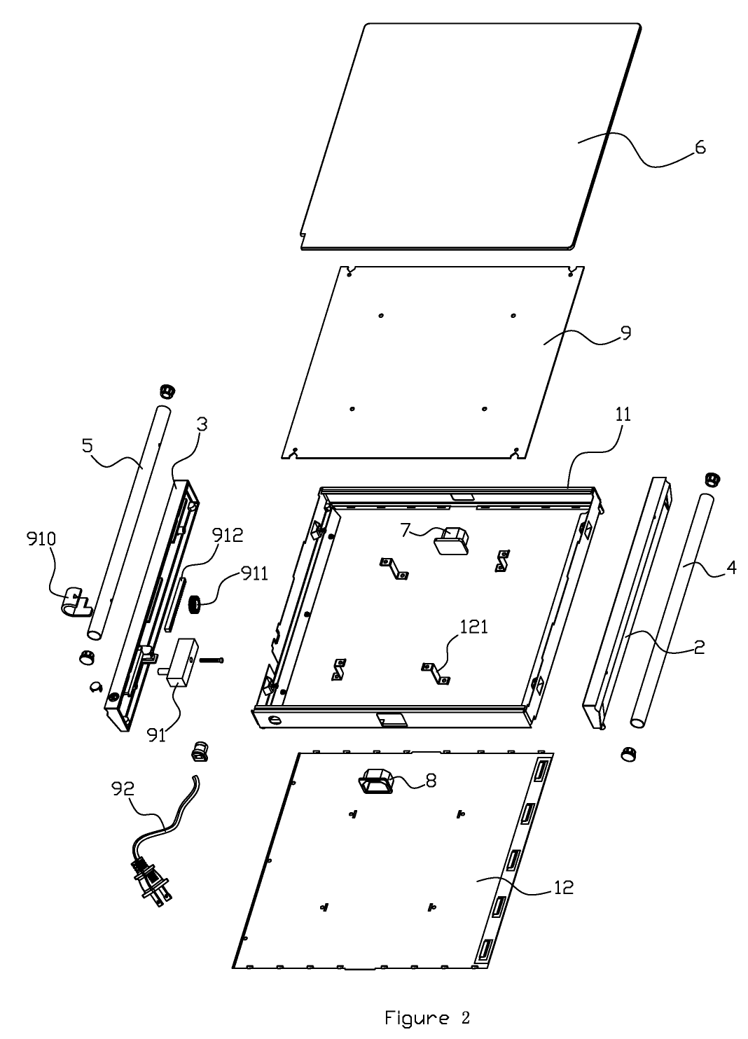

Referring to FIG. 1 and FIG. 2, a main grill including a shell 1, a frying plate 6 mounted on the shell 1, an electric heating device mounted inside the shell 1 for heating the frying plate 6, and a power cord 92 for connecting the electric heating device and the power. The shell 1 includes a rectangular frame 11 and a bottom cover 12, herein the bottom cover 12 has hooks, and the bottom of the frame 11 has holes matching the hooks. The bottom cover 12 is located on the bottom of the frame 11 by the cooperation of the hooks and the holes, and the bottom cover 12 and frame 11 are fastened each other by bolts. The frying plate 6 is a glass plate, and a heating plate 9 positioned below the glass plate. The heating plate 9 is located on the bottom cover 12 via four Z-shape brackets 121.

Additionally, two feet 2, 3 are provided in the present invention. The feet 2, 3 installed in the two parallel sidewall of the frame 11 from two terminal directions to middle part respectively, and fastened by bolts from inside to outside. Handles 4, 5 disposed in the outside of the feet 2, 3 respectively are fastened to the feet 2, 3 by bolts from inside to outside.

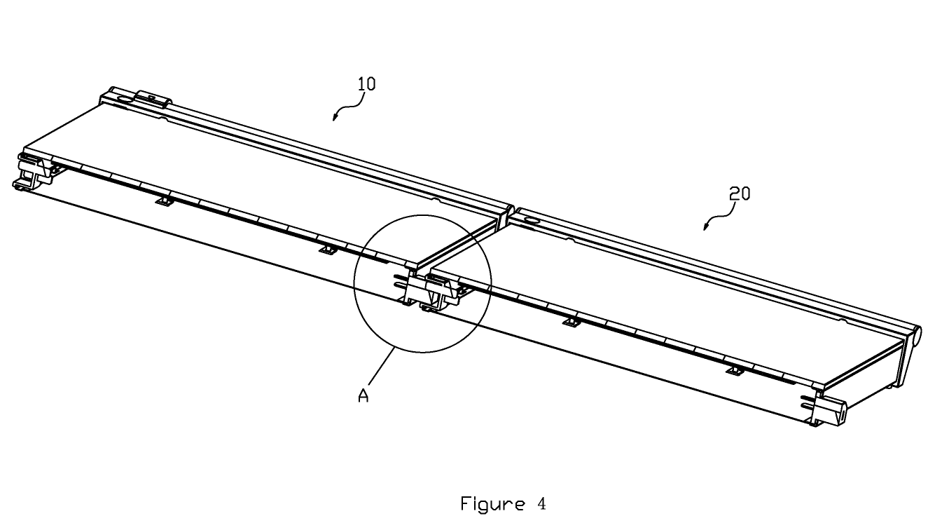

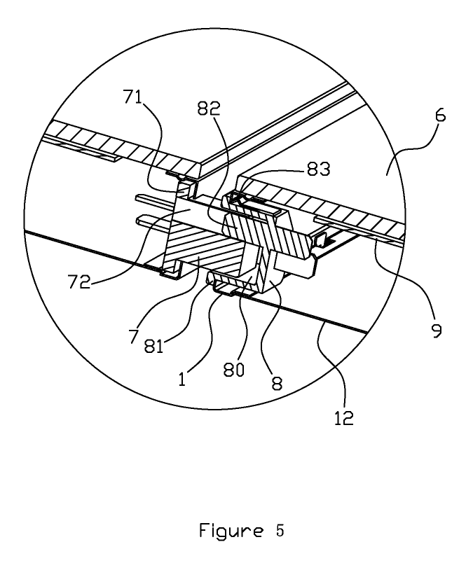

The other parallel sidewalls which are not having feet 2, 3 of the frame 1, one of which the power socket 7 is positioned on, and referring to FIG. 4 and FIG. 5, the power socket 7 is protruding though the frame 1 from inside to outside, and its inside terminal forms a flange 71 coupling with the frame 1 by bolts. The power socket 7 has a power jack 72 and it is used for providing power to the connecting secondary grill.

Referring to FIG. 2, the above-mentioned feet 3 has a thermostat 91 for controlling a temperature of the heating plate 9 inside the feet 3. A gear 911 is formed on the knob of the thermostat 91, and a rack 912 meshing with the gear 911 is located slidable inside the feet 3. The push-button 910 is located slidable in a handle 5 corresponding to the feet 3, and the push-button 910 has an extending terminal inserted in the rack 912. A push-button 910 is pushed to let the gear 911 rotate via the movement of the rack 912, thus adjusting the temperature of the thermostat 91. These structure and the heating plate 9 form the electric and temperature control device. The power cord 92 is used in connecting power source to the electric heating device.

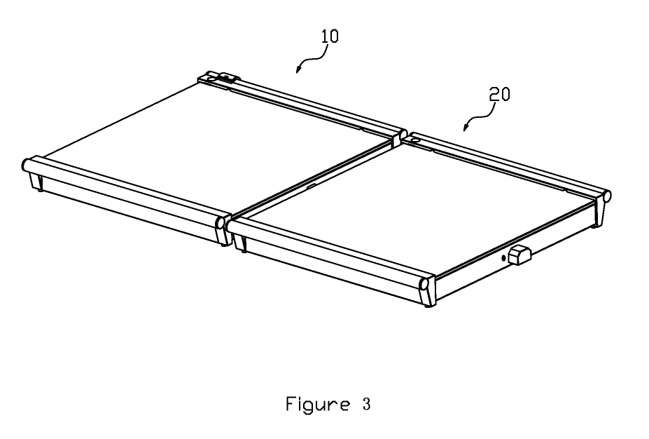

The most structure of the secondary grill is the same as the main grill, and the difference between them is that the secondary grill does not have a power cord 92 and temperature control device. For the sake of illustrating conveniently, referring to FIG. 2, the secondary grill has a power plug 8 in the other side, referring to FIG. 4 and FIG. 5, the power plug 8 has a groove 80 whose size and shape is matching the power socket 7. The groove 80 has an insert 82 matching the jack 72 of the power socket 7, the power plug 8 located through shell 1 from outside to inside, and its outside terminal having a flange 81 contacting with the out surface of the shell 1, herein its side-surface having a flexible hook 83 contacting with the inside surface of the shell 1 so as to make the power plug 8 locate in the shell 1. The power plug 8 used in the power socket 7 of the main grill is to gain the needed power of the secondary grill from the main grill. Referring to FIG. 3, it shows the status of the connection of the main grill and the secondary grill. Certainly, the secondary grill 20 having the power socket 7 also can connect the third grill by inserting the power socket 7 into the power plug 8 to provide power for the third grill.

Specifically, the main grill has a power cord 92 and a power socket 7, and it connects the power source through the power cord 92. Each secondary grill has a power socket 7 and a power plug 8, and they gain power from the main grill or superior secondary grill through the power plug 8. In the present embodiment, the main grill 10 and secondary grill have some differences in structure, and they can not replace each other.

Certainly, the main grill could have a power plug 8 and does not use the power cord 92 for obtaining power, thus the main grill is regarded as a secondary grill. The secondary grill could also add a power cord 92 and a temperature control device to be a main grill. Namely, the main grill can be designed as the same structure as the secondary grill, so that they can replace each other randomly.

Further more, the distance between the portions of the foot 2 and foot 3 protruding out of the bottom of the frame 1 is longer than the distance between the other two parallel sidewalls which are without feet, so the main grill and secondary grills can be piled up vertically to each other. The two close grills can be rotated 90 degree relatively to each other, and they can be located on each other by feet 2, 3.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

We claim:

1. A multi grill, comprising:
a main grill comprising a first shell, a first frying plate mounted on said first shell, a first electric heating device mounted inside said first shell for heating said first frying plate, and a first power cord connecting said first electric heating device and a power source; and
at least a secondary grill comprising a second shell, a second frying plate mounted on said second shell, a second electric heating device mounted inside said second shell for heating said second frying plate; wherein
said main grill connects said secondary grill via a first power plug and a first power socket, and said secondary grill gains its power supply for said second electric heating device from said main grill.

2. The multi grill of claim 1, wherein said secondary grill includes at least two grills coupling together via a second power plug and a second power socket in turn, and an electric heating device of a rear secondary grill obtains power from a front secondary grill.

3. The multi grill of claim 1, wherein said secondary grill has a second power cord connecting said second electric heating device and said power source.

4. The multi grill of claim 1, wherein said first power socket protrudes through said first shell from the inside to outside, and its inside terminal forms a flange coupling with said first shell via bolts; said first power plug has a groove whose size and shape is matching said first power socket, and said groove has an insert matching a jack of said first power socket, said first power plug mounted through said first shell from outside to inside, and its outside terminal having a flange contacting with the outer surface of said first shell, its side surface having a flexible hook contacting with the inside surface of said first shell, thereby making said first power plug be fixed in said first shell via said hook.

5. The multi grill of claim 1, wherein said shell includes a rectangular frame and a bottom cover, said bottom cover having hooks, the bottom of said frame having holes matching said hooks, said bottom cover located below said frame through the cooperation of said holes and said hooks, and said bottom cover is locked and fastened with said frame by bolts.

6. The multi grill of claim 5, wherein at least one of said frying plates is a glass plate, a heating plate positioned below said glass plate, and said heating plate is located on said bottom cover by four Z-shape brackets.

7. The multi grill of claim 5, further comprising two feet installed in the two parallel sidewalls of said frame, and fastened by bolts; handles fastened to the outside of said two feet by bolts.

8. The multi grill of claim 7, wherein the distance between the portions of said two feet protruding out the bottom of said frame is longer than the distance between the other two parallel sidewalls which are without said feet.

9. The multi grill of claim 7, wherein a thermostat for controlling the temperature of said heating plate is located inside one of said feet, a gear formed on the turning knob of said thermostat, a rack meshed with said gear located slidable inside said feet, a push-button mounted slidable on the handle corresponding to said feet, and said push-button has a extending terminal inserted in said rack.

10. The multi grill of claim 3, wherein said frying plates are glass plates.
